(19) United States
(12) Patent Application Publication
(10) Pub. No.: US 2017/0096903 A1
(43) Pub. Date: Apr. 6, 2017

(54) RETAINING DEVICE FOR AXIALLY RETAINING A BLADE AND ROTOR DEVICE WITH SUCH A RETAINING DEVICE

(71) Applicant: Rolls-Royce Deutschland Ltd & Co KG, Blankenfelde-Mahlow (DE)

(72) Inventors: Thomas SCHIESSL, Koenigs Wusterhausen (DE); Markus WEINERT, Rangsdorf (DE)

(21) Appl. No.: 15/287,361

(22) Filed: Oct. 6, 2016

(30) Foreign Application Priority Data
Oct. 6, 2015 (DE) 10 2015 116 935.5

(51) Int. Cl. F01D 5/30

(52) U.S. Cl. CPC F01D 5/3007; F05D 2260/30

(57) ABSTRACT

A securing device with multiple securing segments for the axial retaining of at least one rotor blade at a disc wheel a rotor device of a continuous-flow machine. The securing device has at least one effective area that is arranged in a radially inner area and that in the mounted state is embodied for acting together with the disc wheel in the axial direction of the rotor device, and a further effective area that is arranged in a radially outer area at a securing segment and that in the mounted state is embodied for acting together with at least one rotor blade in the axial direction of the rotor device. At least one securing segment has an additional effective area, that in the mounted state is embodied for acting together with the disc wheel in the radial direction of the rotor device. What is further described is a rotor device with such a securing device.

This application claims priority to German Patent Application DE102015116935.5 filed Oct. 6, 2015, the entirety of which is incorporated by reference herein.

The invention relates to a securing device with multiple securing segments for the axial retaining of at least one rotor blade at a disc wheel of a rotor device of a continuous-flow machine according to the kind as it is more closely defined in the generic term of patent claim 1, and a rotor device according to the kind as it is more closely defined in the generic term of patent claim 7.

Known from practice are rotor devices of continuous-flow machines embodied as jet engines that are embodied with disc wheels as well as rotor blades that are circumferentially connected to the latter. The rotor blades have blade roots that have a cross section that is embodied in a fir-tree-shaped or dovetail-shaped manner, and via which the rotor blades are arranged in the disc wheel inside holding grooves that extend in the axial direction. Securing rings having multiple securing segments are known for axially retaining the rotor blades at the disc wheel. The securing segments are arranged in a radially inner area inside grooves of the disc wheel and in a radially outer area inside grooves of the rotor blades, wherein the securing segments are respectively arranged next to each other in the circumferential direction of the rotor devices, respectively acting together with the lateral end faces.

During operation of the jet engine, the securing segments are pressed outward in the radial direction as a result of the centrifugal forces that act on them due to the rotation of the rotor device, wherein in the area of the grooves of the rotor blades the securing segments are supported at the same. Here, stresses occur in the area of the rotor blades in particular in the area of the groove base. In addition, the rotor blades support these forces at the disc wheel, also in the area of the blade roots. In order to be able to absorb these forces, the blade roots and the disc wheel disadvantageously have to be embodied for example with a great length in the axial direction of the rotor device. This in turn results in a correspondingly high weight of these rotor devices.

What is further known from practice are securing rings that are embodied as full rings and that are thus configured to run along the entire circumferential direction of the rotor device. For mounting such a full ring, for example a snap ring or piston ring is first arranged inside a groove of the disc wheel, and subsequently the full ring that has already been brought into operative connection with the rotor blades is inserted into the groove in the axial direction of the rotor device via the snap ring or the piston ring. During operation of the jet engine, the full ring is supported at the disc wheel in the radial direction, so that the forces that have to be supported by the blade roots of the rotor blades are lower as compared to the segment solution that has been described more closely above, and they can thus be embodied so as to be shorter in the axial direction.

However, such a solution has the disadvantage that, on the one hand, the full ring is exposed to strong loads by the high temperatures that occur during operation of the jet engine and, on the other hand, by a high temperature gradient between the radially inner area and the radially outer area of the full ring. Here, material stresses can occur in the full ring that may even result in the full ring cracking, since, in contrast to a segment solution, the full ring also transfers circumferential stresses and cannot expand in the circumferential direction. Thus, securing rings that are embodied as full rings can disadvantageously only be used at lower temperatures or temperature gradients that occur during operation or they require a special cooling or limitations of the installation space.

What is further known from practice are axial securing elements that in a radially inner area are embodied with a full ring that is arranged inside a groove of the disc wheel through a snap ring or a piston ring in the manner that is described closer above. A plurality of securing segments is provided in the radial direction of the rotor device at the outside of the full ring, acting together with the full ring and respectively acting together with one or multiple rotor blades via a groove. Since such a full ring has a shorter extension in the radial direction of the rotor device than the full ring that has been described more closely above, a lower temperature gradient is present in the area of the full ring during operation of the rotor device, so that this embodiment can also be used in application cases where it is no longer possible to use the full ring described more closely above.

However, in this embodiment the securing segments are again supported at the rotor blades during operation of the rotor device, so that the centrifugal forces that are acting during operation of the jet engine have to be absorbed by a disadvantageously larger dimensioned disc wheel and blade roots that are embodied in a correspondingly large manner, wherein the centrifugal forces are weaker because of the lower mass of these securing segments as compared to the embodiment with only securing segments that has been mentioned first.

Further, this solution with a full ring and securing segments has the disadvantage that, due to the necessary connection area of the securing segments to the full ring, forces can only be reliably absorbed in one axial direction of the rotor device, so that a securing ring or other design solutions for the axial retaining of the blades also have to be provided on another axial side of the disc wheel and of the rotor blades. This results in a higher complexity, additional costs, and increased weight.

Thus, the present invention is based on the objective to provide a securing device for the axial retaining of at least one rotor blade at a disc wheel of a rotor device as well as a rotor device, which have an improved temperature resistance, and wherein a rotor device that comprises the securing device has a lower weight and can be operated for a desirably long operational life.

According to the invention, this objective is achieved through a securing device with the features of patent claim 1, or a rotor device with the features of patent claim 7.

What is proposed is a securing device for the axial retaining of at least one rotor blade at a disc wheel of a rotor device of a continuous-flow machine with multiple securing segments, wherein the securing device has at least one effective area that is arranged in a radially inner area and that in the mounted state is embodied for acting together with the disc wheel in the axial direction of the rotor device, and a further effective area that is arranged at a securing segment in a radially outer area and that in the mounted state is embodied for acting together with at least one rotor blade in the axial direction of the rotor device. According to the invention, it is provided that at least one securing segment has an additional effective area that in the mounted state of the securing device is embodied for acting together with the disc wheel in the radial direction of the rotor device.

A securing device according to the invention, which can preferably be used in a turbine, for example a low-pressure, medium-pressure or high-pressure turbine of a continuous-flow machine that is embodied as a jet engine or a stationary gas turbine, has the advantage that the centrifugal forces that act on the securing segments during operation of the rotor device can be supported at a disc wheel via the additional effective area, so that an outer area of the securing segments as viewed in the radial direction is not supported at the rotor blades during operation of the rotor device, and a connection area of the rotor blades to the disc wheel does not have to absorb these forces. In addition, with the securing device according to the invention it is thus possible to avoid stresses in the area of the rotor blades due to direct load transfer into the disc.

Further, the rotor blades and the disc wheel can be advantageously dimensioned to be small in their connection area in the axial direction of the rotor device, so that a rotor device that is embodied with the securing device according to the invention can have a lower total weight.

At the same time, the securing device according to the invention has a good temperature resistance. During operation of a continuous-flow machine that is embodied with the securing device according to the invention, a high temperature gradient with big temperature differences is present in a radially inner area as compared to a radially outer area of the securing device. Due to the embodiment of the securing device with multiple—for example four to for example twenty—securing segments, these temperature differences can be compensated through the different expansion of the securing segments in the circumferential direction in the radially inner area and the radially outer area. Thus, the danger of any damage to the securing device occurring due to thermal stresses is advantageously low even if high temperature gradients are present, so that the securing device according to the invention advantageously has a long operational life span.

In an advantageous embodiment of a securing device according to the invention it can be provided that the additional effective area is arranged at the at least one securing segment in the mounted state of the securing device in a manner substantially concentric to a central axis of the rotor device or the securing device. In this manner, an areal acting together with a corresponding surface of a disc wheel of a rotor device can be achieved in a simple manner, wherein a desired surface pressure between these surfaces can be achieved in the mounted state of the securing device through a corresponding choice of the extension of the additional effective area in the axial direction of the rotor device.

If the effective areas that are oriented in the axial direction in the mounted state of the securing device are embodied so as to be substantially parallel to a plane that extends perpendicular to a central axis of the rotor device, a securing of the rotor blades at a disc wheel in the mounted state of the securing device can be achieved through an advantageous force transmission.

In order to create a defined abutment area between the rotor blades and the securing segments in the mounted state of the securing device, the at least one securing segment can have a support area that in the mounted state is embodied for acting together with a rotor blade of the rotor device.

Through the arrangement of the axial support area in the mounted state of the securing device in an area of the securing segment that is central with respect to the radial direction of the rotor device, it can be achieved here in a simple manner that a support lever that acts during a movement of the rotor blade in the one or the other axial direction is approximately the same for a movement of the rotor blade in both axial directions.

In an advantageous embodiment of a securing device according to the invention, it can be provided that it comprises a securing element which comprises the effective area that in the mounted state acts together with the disc wheel in the axial direction, and which in the mounted state acts together with the at least one associated securing segment in the radial direction and/or the axial direction of the rotor device.

On the one hand, the securing element facilitates easy mounting of the securing device, and, on the other hand, secures the securing segments against a radially inward movement without centrifugal forces when the rotor device is idle. Via a support surface that extends concentrically to a rotor axis, the securing element preferably acts together with a surface of the securing segments that also extends concentrically to the rotor axis, and via a support surface that is arranged perpendicular to the rotor axis acts together with a surface of the securing segments that in the mounted state of the securing device is parallel to the same. Here, the effective area can be a part of the securing element that can for example be embodied as a snap ring or a piston ring.

In an embodiment of the securing device according to the invention that is easy to mount, the at least one securing segment has a hook-shaped area in a radially inner area, extending in the axial direction, wherein the effective area that in the mounted state acts together with the disc wheel in the axial direction is configured at an inner wall of the hook-shaped area. Thus, the hook-shaped area can be embodied for surrounding a projection of the disc wheel in the mounted state of the securing device, and in particular can act together with the disc wheel via an undercut. Securing segments that are embodied in such a manner can be brought into operative connection with a disc wheel and the rotor blades of a rotor device in a simple manner from radially inside.

What is further described is a rotor device for a continuous-flow machine with a disc wheel and multiple rotor blades that are arranged at the disc wheel in a circumferentially distributed manner, wherein the rotor blades are respectively arranged via a blade root inside recesses of the disc wheel that substantially extend in the axial direction of the rotor device, and wherein a securing device with multiple circumferentially distributed securing segments as it has been described more closely above is provided for the axial retaining of the rotor blades at the disc wheel.

Because the securing segments are supported at the disc wheel, the rotor blades and the disc wheel of the rotor device according to the invention can be embodied with a shorter axial length in the connection area, so that the rotor device is characterized by a lower weight and low stresses in the area of the rotor blade during operation of the rotor device. In addition, the rotor device has a long service life and can also be used in application cases where high temperature gradients occur in the radial direction of a rotor axis, as the securing segments can expand in the circumferential direction of the rotor axis at high temperatures. As compared to conventional rotor devices, which have a securing ring that is embodied with segments, the rotor device according to the invention can be embodied with a lower number of securing segments, since the centrifugal forces that act during operation act directly at the disc wheel and do not have to be transmitted via the blade roots of the rotor blades.

The prevention of design related additional radial loads of the blade retention device or securing device and of the wheel head sealing system onto the blade itself is a crucial advantage of the securing device and the rotor device that are embodied according to the invention. In this manner, an easy and efficient design of the wheel head is achieved, which is in particular of high importance when rotational speeds are increased to achieve higher levels of turbine-efficiency. This can gain particular importance when ceramic blade materials are introduced into the design practice of high-pressure turbines, as they restrict the possibilities for absorbing additional radial loads by the axial securing device even further. The securing device and rotor device according to the invention show a design for completely avoiding additional radial loads also at possible future high-pressure turbine rotor devices.

In addition, the segmented embodiment of the securing device has the advantage that high-temperature-resistant and heavy-duty nickel-based superalloys can be used, since the restriction of conventional systems to rotating parts from forging blanks does no longer apply. Accordingly, it is also possible to use manufacturing methods that are known from the blade commodity, as for example a single-crystal or multi-crystal mold cast, or metal injection molding. This opens up additional possibilities when it comes to detail design and optimization.

For example, between four and twenty securing segments can be provided, wherein the securing device preferably has only four or five securing segments. The lower the number of securing segments, the less potential leakage locations are present between securing segments that are adjacent in the circumferential direction of the rotor device, with correspondingly weak leakage flows.

Here, an extension of the securing segments in the circumferential direction of the rotor device can in particular be selected in such a manner that the securing segments are secured in the mounted state against an inward movement in the radial direction of the rotor device, and an axial retaining function is reliably fulfilled.

In an advantageous embodiment of the rotor device according to the invention, it can be provided that the disc wheel has a first support surface and a second support surface, and that the rotor blades have a further support surface, wherein the first support surface of the disc wheel acts together with at least one effective area of the securing device that is oriented in the axial direction, the second support surface acts together with an additional effective area of the securing segments that is oriented in the radial direction, and the further support surface acts together with the further effective area of the securing segments that is oriented in the axial direction. All support surfaces and effective areas, which in the mounted state of the securing device have the same orientation to each other, abut each other in particular in a planar manner during operation of the rotor device.

In an advantageous design of the rotor device, the disc wheel has a recess, in the area of which the first support surface is arranged. The recess is preferably delimited by a projection in a radially inner area in the axial direction, with the projection comprising the first support surface and in particular acting together with the securing element described more closely above in the mounted securing device.

The disc wheel can have a groove that is formed by a projection and that is open inward in the radial direction of the rotor device, wherein the first support surface of the disc wheel is a part of the groove, and wherein the projection in particular also comprises the second support surface. In this manner, the disc wheel is configured so as to be particularly simple in design and weight-optimized.

Therefore, the disc wheel, which is classified as a safety-relevant structural component or “critical part” in aeronautical engineering, can be embodied in a strongly simplified manner, wherein so-called 3D features, such as e.g. bayonet contours, which always have to be manufactured in a laborious manner and partially have to be manually deburred, and furthermore usually also represent a feature of the disc wheel that has a limited service life, can be avoided.

In an advantageous embodiment of the rotor device according to the invention, the securing segments surround the projection of the disc wheel, wherein for this purpose the securing segments are in particular embodied with a hook-shaped area in a radially inner area. Such securing segments can be mounted in a simple manner, as they can be brought into mesh with the disc wheel as well as with the rotor blades from radially inside if the rotor blades are already arranged inside the recesses of the disc wheel. A displacement of the securing segments with respect to the disc wheel in the axial direction of the rotor device is reliably prevented in particular through an undercut of the securing segment with the disc wheel.

The securing segments of the rotor device according to the invention can have lateral surfaces that are embodied so as to be substantially parallel with respect to each other or so as to extend substantially in the radial direction of the rotor device as seen in the circumferential direction of the rotor device. At first, in particular the mounting of the securing segments with lateral surfaces oriented in the radial direction is performed, wherein the last securing segment to be mounted has lateral surfaces that are embodied so as to be parallel to each other, so that this securing segment can be brought in operative connection with two securing segments that are respectively adjacent in the circumferential direction substantially in the extension direction of the lateral surfaces.

The securing segments can be embodied in such a manner that a distance in the radial direction of the rotor device between securing segments that are adjacent in the circumferential direction is embodied so as to be substantially constant or V-shaped. A gap that is embodied so as to be V-shaped has the advantage that in particular in the radial direction of the rotor device a distance between the adjoining securing segments can be larger outside than inside in the radial direction of the rotor device, so that in the radially outer area, in which high temperatures or temperature gradients are present during operation of the rotor device, a larger expansion of the securing segment is possible than in the radially inner area. In the area that is located inside in the radial direction, the securing segments are in particular embodied in such a manner that the gap corresponds to a minimal clearance as it is predetermined by tolerances.

In addition to the design with a view to minimal gaps in the circumferential direction, the leakages from the secondary air system related thereto can be further minimized if the lateral surfaces of at least two adjacent segments are embodied in a design in which they axially overlap in the gap area. Here, gap overlapping can be provided in all securing segments.

In an advantageous embodiment of a rotor device according to the invention, at least one retaining appliance is provided for retaining one or multiple securing segments in its or their position in the mounted state. Via the retaining appliance, that can for example be embodied as a wire or a small plate to be deformed, it can be prevented in a simple manner that for example a securing segment embodied with parallel lateral surfaces is moved inward in the radial direction of the rotor device in an undesired manner in a non-rotating operational state of the rotor device without any centrifugal forces.

In order to ensure a play-free positioning of the rotor blade with respect to the disc wheel, at least one securing segment can be pre-loaded during mounting.

The securing device according to the invention as well as the rotor device according to the invention can for example be used in continuous-flow machines that are embodied as stationary gas turbines or as jet engines, and are in particular used in any stage of a turbine, for example high-pressure, medium-pressure or low-pressure turbines. Further, the securing device according to the invention and also the rotor device according to the invention can also be used in a compressor or a fan of a continuous-flow machine, for example.

The features specified in the patent claims as well as the features specified in the following exemplary embodiments of the securing device and the rotor device according to the invention are suitable for further developing the subject matter according to the invention respectively on their own or in any combination with each other.

Further advantages and advantageous embodiments of a securing device and a rotor device according to the invention follow from the patent claims and the exemplary embodiments that are described in principle by referring to the drawings, wherein, with a view to clarity, the same reference signs are respectively used for structural components having the same design and functionality.

Herein:

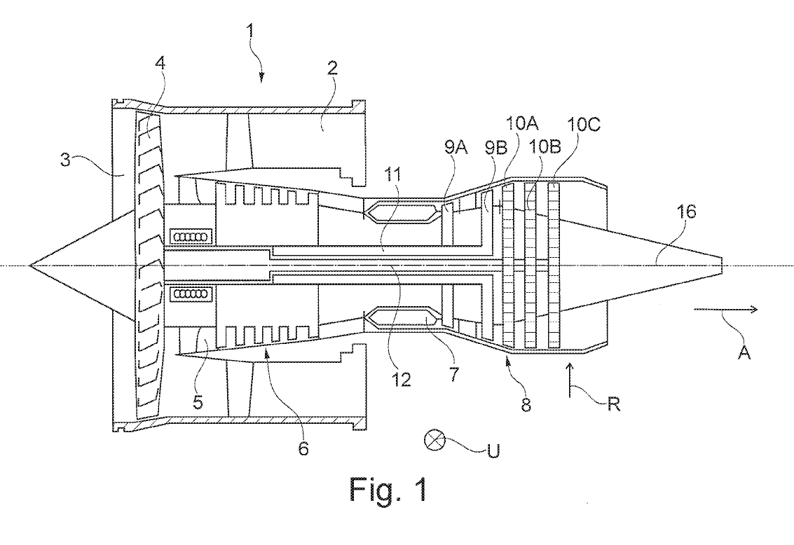

FIG. 1 shows a strongly schematized longitudinal section view of a jet engine that has a turbine with multiple rotor devices;

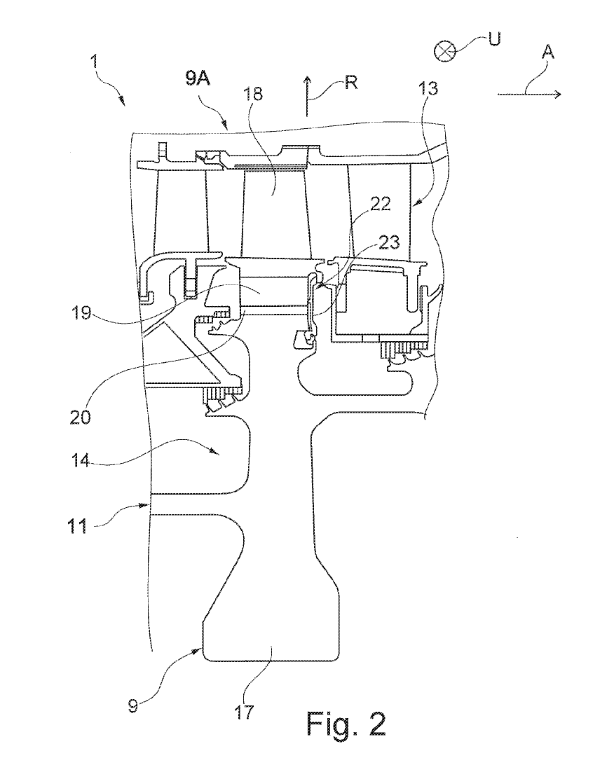

FIG. 2 shows a schematized section of the jet engine of FIG. 1 with a rotor device comprising a disc wheel and rotor blades that are circumferentially arranged thereat, wherein the rotor blades are respectively secured at the disc wheel in the axial direction by means of a securing device;

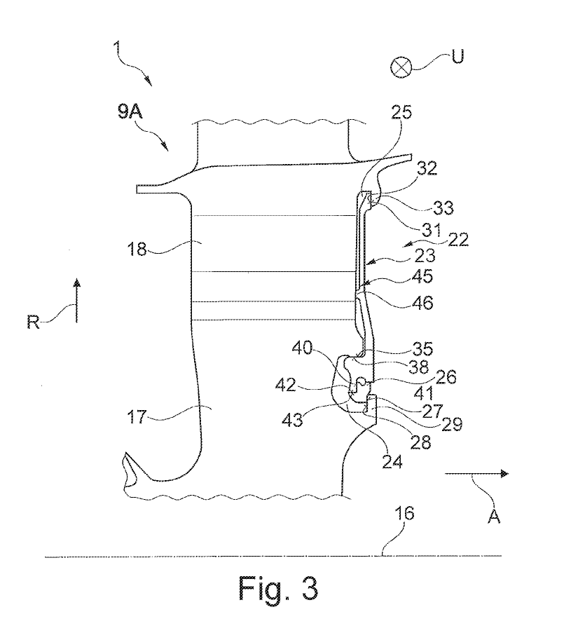

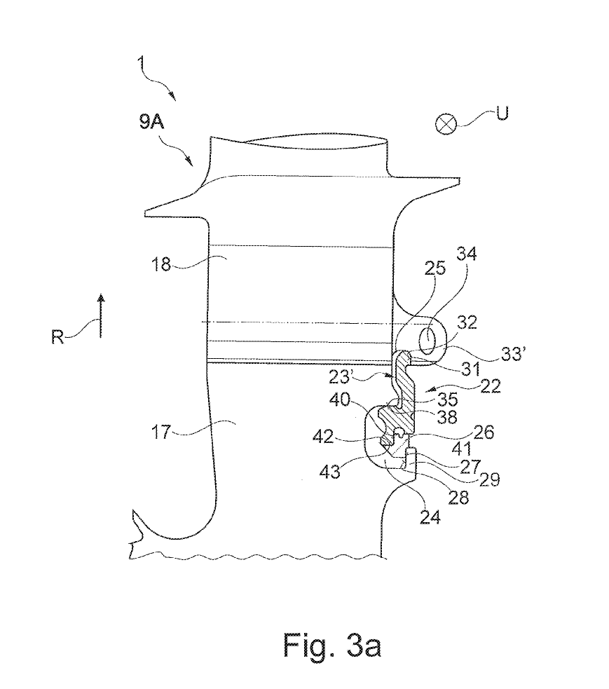

FIG. 3 shows a simplified rendering of an enlarged section of FIG. 2, wherein the securing device can be seen in more detail;

FIG. 3a shows a rendering of a security device at rotor blades that is in principle embodied according to the embodiment in FIG. 3 that corresponds to FIG. 3, with the rotor blades being configured with an axial cooling air outlet that forms a microturbine;

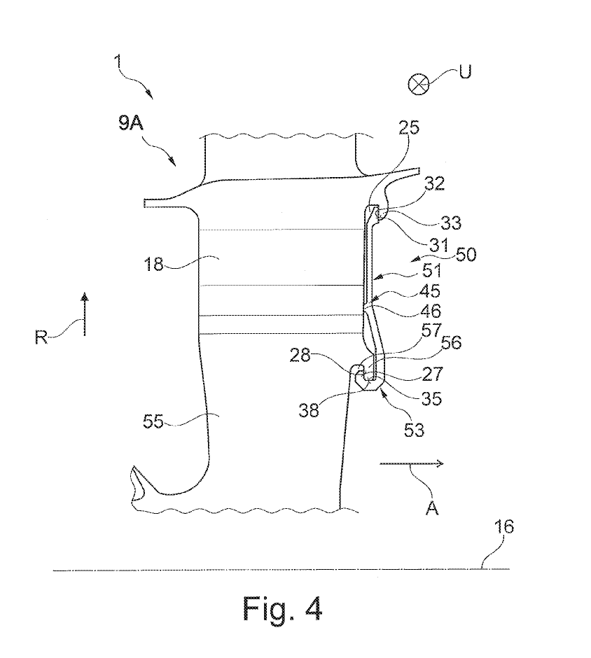

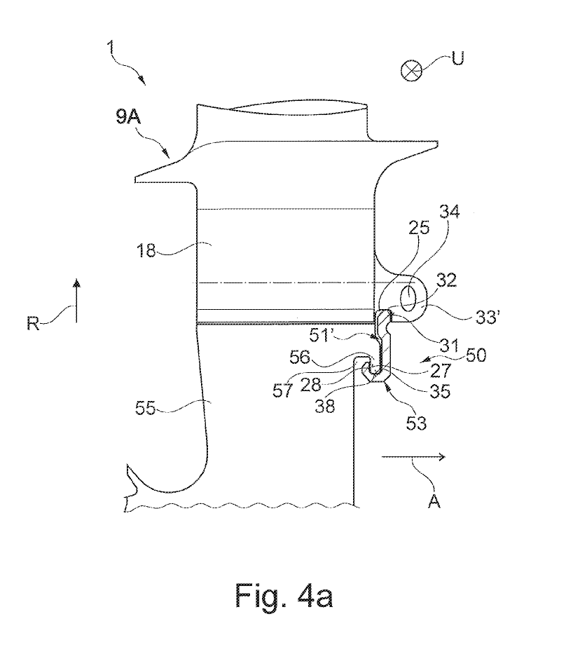

FIG. 4 shows a view of the rotor device according to FIG. 2 that corresponds to FIG. 3, wherein a second embodiment of a securing device can be seen;

FIG. 4a shows a view of a security device at rotor blades corresponding to

FIG. 4 that is in principle configured according to the embodiment in FIG. 4, with the rotor blades being configured with an axial cooling air outlet that forms a microturbine;

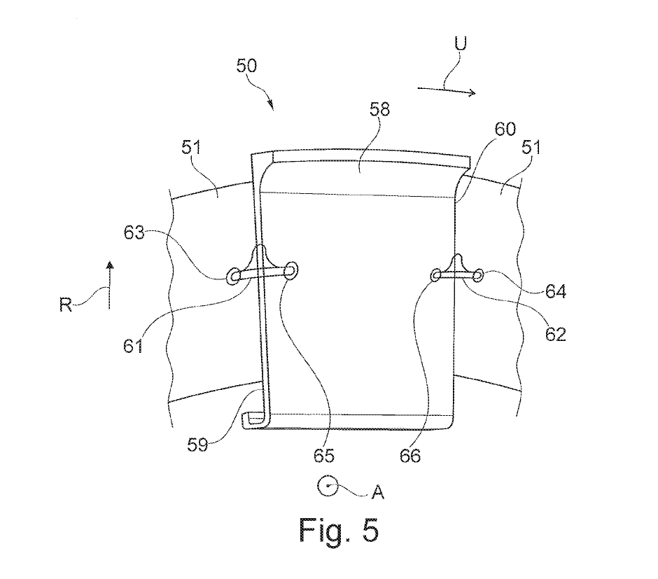

FIG. 5 shows a view of a section of the securing device according to FIG. 4 in a strongly simplified manner, wherein a retaining appliance can be seen in more detail;

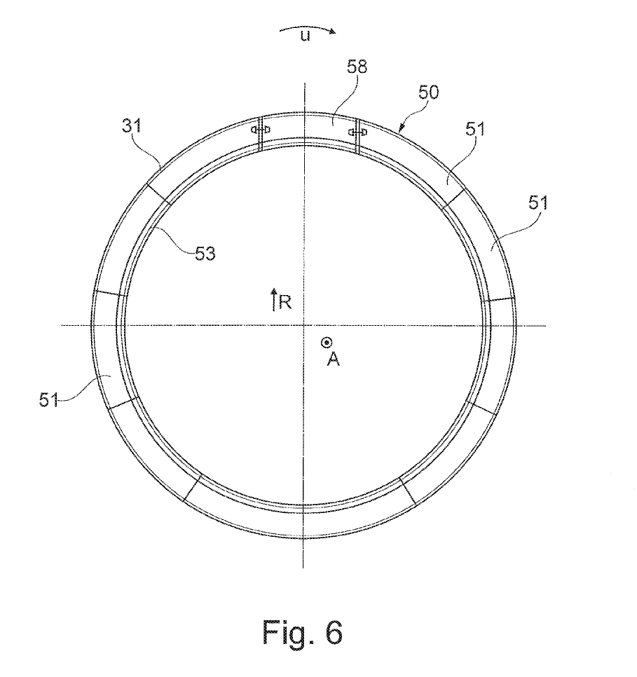

FIG. 6 shows a strongly simplified view of the securing device according to

FIG. 4 from the rear side in isolation with numerous securing segments;

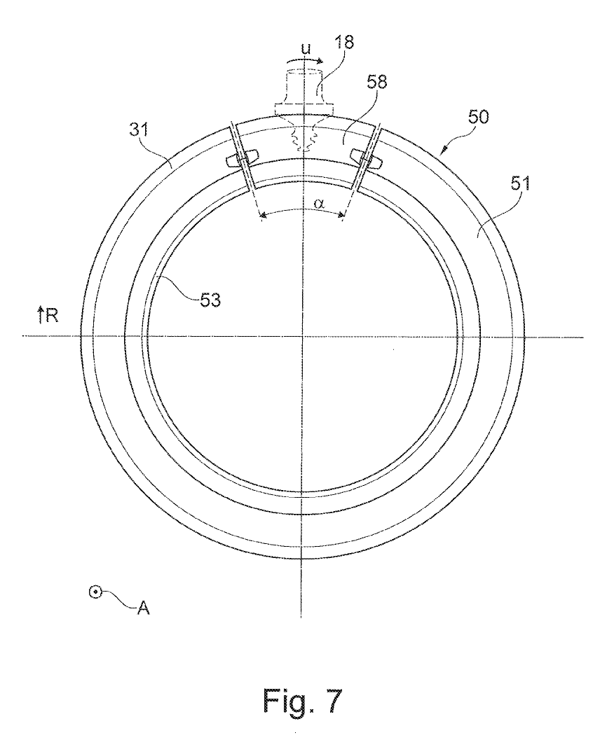

FIG. 7 shows a view of a further embodiment of the securing device corresponding to the rendering of FIG. 6 with a symbolically indicated rotor blade, wherein the securing device is embodied in the kind of a snap ring with an end segment; and

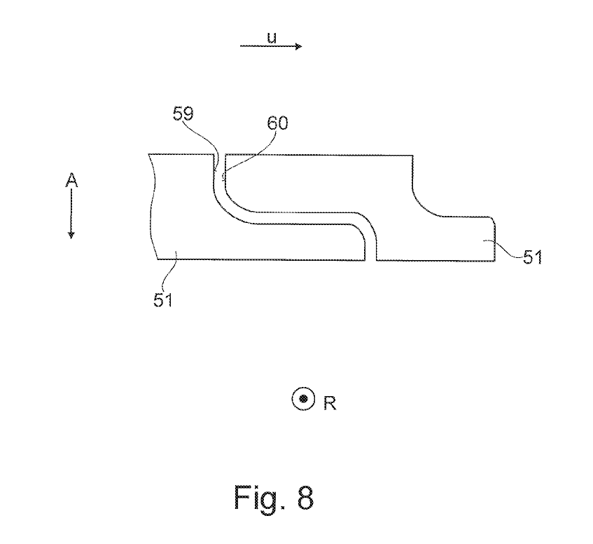

FIG. 8 shows the lateral surfaces of two adjoining securing segments in isolation, wherein the latter are embodied so as to axially overlap each other.

FIG. 1 shows a continuous-flow machine that is embodied as a jet engine 1 in a longitudinal section view, wherein the jet engine 1 is configured with a bypass channel 2 and an inflow area 3. A fan 4 connects downstream to the inflow area 3 in a per se known manner. In turn, downstream of the fan 4 the fluid flow in the jet engine 1 is divided into a bypass flow and a core flow, wherein the bypass flow flows through the bypass channel 2 and the core flow flows into an engine core or core flow channel 5, which is again embodied in a per se known manner with a compressor appliance 6, a burner 7, and a turbine appliance 8.

In the present case, the turbine appliance 8 is embodied in multiple-stage design with two high-pressure rotor devices 9A, 9B of which the rotor device 9A can be seen in more detail in FIG. 2, and three substantially comparatively designed low-pressure rotor devices 10A, 10B, 10C.

Here, the rotor device 9A and a stator device 13 that is arranged downstream of the rotor device 9A in the axial direction A of the jet engine 1 form a first stage 14 of the turbine appliance 8. The rotor device 9A is embodied with a centrally arranged disc wheel 17, which is connected to an engine shaft 11 and is mounted so as to be rotatable around a central axis 16. A plurality of rotor blades 18 is circumferentially arranged at the disc wheel 17 in the radially outer areas, wherein for this purpose the rotor blades 18 respectively have a blade root 19 that is shown here only schematically and that is configured with a so-called fir-tree profile, and via which the rotor blades 18 are respectively arranged in a known manner inside recesses 20 of the disc wheel 17 which substantially extend in the axial direction inside the disc wheel 17 and correlate with the profiled blade roots 19.

In the present case, for the purpose of axially retaining the rotor blades 18 with respect to the disc wheel 17, a securing device 22 is provided on a side of the rotor device 9A that is facing away from the flow with respect to a flow direction of a working gas inside the core flow channel 5, which comprises multiple, preferably approximately four or five, securing segments 23 that are substantially embodied so as to be structurally identical. Here, the flow direction of the working gas inside the core flow channel substantially corresponds to the axial direction A of the jet engine 1.

In an inner area with respect to a radial direction R of the jet engine 1, the securing device 22 that can be seen in FIG. 3 in more detail is arranged inside a recess 24 of the disc wheel 17 that extends in the circumferential direction U of the jet engine 1, and in an outer area with respect to the radial direction R of the jet engine 1 inside a groove 25 of the rotor blades 18 that extends in the circumferential direction U of the jet engine 1.

In an area of the recess 24 of the disc wheel 17, the securing device 22 has a securing element that is embodied as a snap ring 26 here, and that is embodied with an effective area 27 that is arranged substantially perpendicular to the axial direction A of the jet engine 1, with its surface being oriented in the flow direction A.

Via the effective area 27, the snap ring 26 acts together with a first support surface 28 of the disc wheel 17 that is also located substantially in a plane perpendicular to the axial direction A of the jet engine 1, and that in the present case is a part of a projection 29 that delimits the recess 24 at least in certain areas in the axial direction A of the jet engine 1 and that extends substantially in the radial direction R of the jet engine 1. Here, a surface of the part of the projection 29 that comprises the support surface 28 is oriented counter to the flow direction A.

In the radially outer area, the securing segment 23 has a further effective area 31, which is again located substantially in a plane perpendicular to the axial direction A of the jet engine 1 and is oriented downstream. This further effective area 31 is provided for acting together with a further support surface 32 that is part of a projection 33 that delimits the groove 25 in the axial direction A of the jet engine 1 and that substantially extends in the radial direction R of the jet engine 1. Here, the further support surface 32 is also arranged in a plane substantially perpendicular to the axial direction A of the jet engine 1, wherein a surface of a part of the projection 33 that comprises the further support surface 32 is oriented counter to the flow direction A.

Further, the securing segment 23 is embodied in the radially inner area with an additional effective area 35 that is arranged in a substantially concentric manner with respect to the central axis 16 of the jet engine 1, wherein a surface of a part of the securing segment 23 that comprises the additional effective area 35 is oriented outward in the radial direction R of the jet engine 1. In the mounted state of the securing device 22, the securing segment 23 acts together via the additional effective area 35 with an additional support surface 38 of the disc wheel 17, which is also embodied in a substantially concentric manner with respect to the central axis 16 of the jet engine 1 and is formed by the disc wheel 17 in the area of the recess 24. Here, a surface of the part of the disc wheel 17 that comprises the additional support surface 38 is oriented substantially inward with respect to the radial direction R of the jet engine 1.

The snap ring 26 as well as the securing segment 23 respectively have two surfaces 40, 41 or 42, 43, via which the two elements act together. Here, the surfaces 40 and 41 are respectively located in a plane that extends in a substantially perpendicular manner with respect to the axial direction A of the jet engine 1, while the surfaces 42 and 43 are arranged in a substantially concentric manner with respect to the central axis 16 of the jet engine 1, so that the securing segment 23 is supported at the snap ring 26 via the surface 40 in the axial direction A of the jet engine 1, and is supported at the disc wheel 17 via its effective area 27.

Via the surface 43, the securing segment 23 is in turn retained by the snap ring 26 against a movement inward in the radial direction R of the jet engine 1, so that it is thus avoided that the securing segment 23 loses mesh with the groove 25 with its radial outer area when the rotor device 9A is not rotating, and is thus securely retained at the disc wheel 17 as well as at the rotor blades 18.

The securing segment 23 further has a support area 45 with a nose 46, via which the securing segment 23 acts together with the at least one rotor blade 18 in the axial direction A of the jet engine 1.

With the securing device 22, the rotor blades 18 are advantageously secured at the disc wheel 17 against a movement in the flow direction or the axial direction A as well as against a movement opposite to the flow direction. If an outer force effect is applied to the rotor blades 18 in the axial direction A with respect to the disc wheel 17, the securing segments 23 are supported at the disc wheel 17 through shearing by means of a lever that extends in the radial direction R of the jet engine 1 from the support area 45 to the inner area of the securing segments 23. However, if an outer force effect counter to the axial direction A with respect to the disc wheel 17 is applied to the rotor blades 18, the securing segments 23 are supported through shearing at the rotor blades 18 by means of a lever that extends in the radial direction R of the jet engine 1 from the support area 45 to the outer area of the securing segment 23.

If the support area 45 is arranged in a substantially central area with respect to the radial direction R of the jet engine 1 between the inner area and the outer area of the securing segment 23, both levers have approximately the same length, so that via the securing segments 23 a movement of the rotor blades 18 can be reliably retained in the as well as counter to the axial direction A.

For the purpose of mounting the securing device 22 at the disc wheel 17 and the rotor blades 18, first a diameter of the snap ring 26, which is embodied with an opening in the circumferential direction, is widened, so that the snap ring 26 can be inserted into the recess 24 at the disc wheel 17 via the projection 29, wherein the snap ring 26 is retained inside the recess 24 with a diameter that is reduced as compared to a diameter in the finished mounting state. Subsequently, the securing segments 23 are brought into mesh with the grooves 25 of the rotor blades 18, which are not yet in mesh with the recesses 20 of the disc wheel 17, with their radial outer areas.

If the rotor blades 18 are inserted into the recesses 20 of the disc wheel 17 substantially in the axial direction of the jet engine 1, the securing segments 23 are also inserted into the recess 24 of the disc wheel 17 and are guided in the radial direction R of the jet engine 1 via the snap ring 26. Subsequently, a diameter of the snap ring 26 is increased, so that the securing segments 23 act together via their surfaces 40, 42 with the surfaces 41, 43 of the snap ring 26, and with the additional effective area 35 act together with the additional, second support surface 38 of the disc wheel 17, and the spring ring acts together with its effective area 27 with the support surface 28 of the disc wheel 17.

In principle it is also conceivable that the securing segments 23 are inserted into the recess 24, into which the snap ring 26 is already inserted, when the rotor blades 17 have already been mounted in the recesses 20 of the disc wheel 17.

In the alternative embodiment shown in FIG. 3a, the securing device 22 has multiple, preferably approximately four or five, securing segments 23′ that are embodied so as to be substantially structurally identical, and that are in principle embodied like the securing segments 23 shown in FIG. 3 with respect to their structure and their effective areas. In contrast to the embodiment according to FIG. 3, here the projection 33′ of the rotor blade 18 with the groove 25 and the further support surface that is configured at the projection 33′ for acting together with the further effective area 31 are part of a coating for a cooling air channel outlet 34 that is configured as a ‘microturbine’. In a manner corresponding to its radial arrangement in the radially inner area of the rotor blade 18, the respective securing segment 23′ is configured so as to be radially shortened.

Such cooling air outlets 34 are configured for example with a nozzle-like extension in the flow direction A for the purpose of decreasing the flow-pressure during exit of the cooling air from an axial cooling air channel of the rotor blade 18, and can be configured with a flow deflection depending on the application case.

In further embodiments it is also conceivable that the projection 33′ forming the ‘microturbine’ is configured as a separate structural component with a suitable fixing at the rotor blade 18, wherein the mesh of the securing segments 23′ is provided in an analogous manner.

FIG. 4 shows an alternatively embodied securing device 50 with securing segments 51, which acts together with the rotor blades 18 in the area of the groove 25 and via the support area 45 in a manner comparable to the securing segments 23. The securing segments 51 are thus embodied in a radially central and outer area in a manner comparable to the securing segments 23 of the securing device 22. In a radially inner area, the securing segments 51 have a hook-shaped area 53, which acts together with the disc wheel 55 that is embodied in the connection area in an alternative manner to the disc wheel 17 in the mounted state of the securing segments 51.

In contrast to the disc wheel 17, the disc wheel 55 does not have recess 24 for this purpose, but a projection 56 that runs all along the circumferential direction U of the jet engine 1 and is configured in a nose-shaped manner, forming a groove 57 that is substantially open inwards in the radial direction R of the jet engine 1.

In the mounted state of the securing segments 51, these surround the projection 56 with the hook-shaped area 53 and mesh with the groove 57 of the disc wheel 55. Thus, the securing segments 51 are arranged inside the projection 56 in the radial direction R of the jet engine 1, wherein, in the area that surrounds the projection 56, the hook-shaped area 53 comprises the additional effective area 35 that is arranged in a substantially concentric manner with respect to the central axis 16 and that is configured for acting together with the additional support surface 38 that is formed by the projection 56 and is facing inward in the radial direction R of the jet engine 1 and is also embodied so as to be substantially concentric to the central axis 16.

Here, the effective area 27 is formed by the part of the hook-shaped area 53 that surrounds the projection 56 and meshes with the groove 57 of the disc wheel 55, and acts together with the support surface 28 that is formed by the projection 56.

If the rotor blades 18 are already arranged inside the recesses 20 of the disc wheel 55, the securing segments 51 can be brought into mesh in a simple manner radially from the inside out with the grooves 25 of the rotor blades 18 on the one hand and with the projection 56 of the disc wheel 55 on the other hand.

For a play-free positioning of the securing segments 23, 51 inside the grooves 25 of the rotor blades 18 and inside the recess 24 of the disc wheel 17, or in the area of the projection 56 of the disc wheel 55, the securing segments 23 or 51 can be arranged in a pre-loaded manner by means of elastic deformation during mounting if the axial tolerances are designed correspondingly.

In the alternative embodiment shown in FIG. 4a, the securing device 22 again has multiple securing segments 51′ that are substantially embodied in a structurally identical manner and that, with respect to their structure and their effective areas, are constructed in principle like the securing segments 51 that are shown in FIG. 4. As in the design variant shown in FIG. 3a in comparison to the embodiment in FIG. 3, the alternatively designed embodiment that can be seen in FIG. 4a is a modification of the embodiment according to FIG. 4 of a rotor blade 18 with a projection 33′, which is part of a coating to form a cooling air channel outlet 34 that is configured as a ‘microturbine’. Just like in the embodiment according to FIG. 3a, the further support surface 32 is arranged in the area of the cooling air outlet 34, wherein the respective securing segments 51′ are configured so as to be correspondingly shortened in their radial expansion.

What can be seen in FIG. 5 is a strongly simplified section of the securing device 50 as viewed in the axial direction A of the jet engine 1. The securing device 50 has substantially structurally identical securing segments 51, which are embodied with lateral surfaces that in particular extend in the radial direction R of the jet engine 1. Via the lateral surfaces, the securing segments 51 that are adjacent to each other in the circumferential direction U of the jet engine 1 act together.

As can be seen in FIG. 5 and FIG. 6, for mounting-related reasons the present securing device 50 has a securing segment 58 configured with two lateral surfaces 59, 60 that are embodied so as to be parallel to each other and that are oriented in the circumferential direction U of the jet engine 1. In this manner, the securing segment 58 can easily be brought into operative connection with the respectively adjacent securing segments 51 after all other securing segments 51 have been mounted.

In order to safely retain the securing segment 58 in the mounted position, two retaining appliances 61, 62 are provided in the present case. Via the respective retaining appliance 61, 62, the securing segment 58 can be connected in a captive manner with the securing segment 51 that is respectively adjacent in the circumferential direction U of the jet engine 1. In the present case, the retaining appliances 61, 62 are embodied as a wire or a sheet metal strip to be deformed that is respectively guided through a recess 63 or 64 of the securing segment 51 and a recess 65 or 66 of the securing segment 58.

In contrast to the embodiment according to FIG. 5 and FIG. 6 with numerous securing segments, in the embodiment shown in FIG. 7, a two-part ring is provided as a securing device 22 or 50, in which the securing device is configured in the kind of a snap ring with an end segment 58, wherein the gaps between the end segment 58 and the securing segment 51 that is remaining as a rest ring are oriented towards a central point of the ring and enclose an angle a inside a quadrant of a circle.

In every embodiment, any leakage in the gap area between the segments of the security device 50 can be minimized if the lateral surfaces 59, 60 of the individual segments 51, 58 axially overlap in the gap area, as can be seen in FIG. 8.

### Parts List

1 continuous-flow machine; jet engine
2 bypass channel
3 inflow area
4 fan
5 core flow channel
6 compressor appliance
7 burner
8 turbine appliance
9A, 9B rotor device (high-pressure)
10A, 10B, 10C rotor device (low-pressure)
11 engine shaft (high-pressure)
12 engine shaft (low-pressure)
13 stator device
14 first stage of the turbine appliance
16 central axis
17 disc wheel
18 rotor blade
19 blade root
20 recesses of the disc wheel
22 securing device
23, 23′ securing segment
24 recess of the disc wheel
25 nut of the rotor blade
26 securing element; snap ring
27 effective area
28 first support surface
29 projection of the disc wheel
31 further effective area
32 further support surface
33, 33′ projection of the rotor blade
34 cooling air outlet
35 additional effective area
38 additional, second support surface
40, 42 surface of the securing segment
41, 43 surface of the snap ring
45 support area
46 nose (support bar)
50 securing device
51, 51′ securing segment
53 hook-shaped area
55 disc wheel
56 projection
57 nut
58 securing segment
59, 60 lateral surface of the securing segment
61, 62 retaining appliance
63, 64, 65, 66 recess
A axial direction of the jet engine
R radial direction of the jet engine
U circumferential direction of the jet engine

1. A securing device for the axial retaining of at least one rotor blade at a disc wheel of a rotor device of a continuous-flow machine with multiple securing segments, wherein the securing device has at least one effective area -(2 that is arranged in a radially inner area and that in the mounted state is embodied for acting together with the disc wheel in the axial direction of the rotor device, and a further effective area that is arranged in a radially outer area at a securing segment and that in the mounted state is embodied for acting together with at least one rotor blade in the axial direction of the rotor device, wherein at least one securing segment has an additional effective area that in the mounted state is embodied for acting together with the disc wheel in the radial direction of the rotor device.

2. The securing device according to claim 1, wherein the additional effective area is arranged at the at least one securing segment in the mounted state in a manner substantially concentric with respect to a central axis of the rotor device.

3. The securing device according to claim 1, wherein the effective that are oriented in the axial direction in the mounted state of the securing device are configured so as to be substantially parallel to a plane that extends perpendicularly to the central axis of the rotor device.

4. The securing device according to claim 1, wherein the at least one securing segment has a support area that in the mounted state is embodied for acting together with a rotor blade of the rotor device, wherein the support area in the mounted state is preferably arranged in an area of the securing segment that is central with respect to the radial direction of the rotor device.

5. The securing device according to claim 1, wherein it comprises a securing element that comprises the effective area, which in the mounted state acts together with the disc wheel in the axial direction, and which acts together in the mounted state with at least one associated securing segment in the radial direction and/or the axial direction of the rotor device.

6. The securing device according to claim 1, wherein, in a radially inner area, the at least one securing segment has a hook-shaped area that extends in the axial direction, wherein the effective area that in the mounted state acts together with the disc wheel in the axial direction is configured at an inner wall of the hook-shaped area.

7. A rotor device for a continuous-flow machine with a disc wheel and multiple rotor blades that are arranged at the disc wheel in a circumferentially distributed manner, wherein the rotor blades are respectively arranged via a blade root inside recesses of the disc wheel that substantially extend in the axial direction of the rotor device, and wherein a securing device according to claim 1 multiple securing segments arranged in a circumferentially distributed manner is provided for the axial retaining of the rotor blades at the disc wheel.

8. The rotor device according to claim 7, wherein the disc wheel has a first support surface and a second support surface, and the rotor blades have a further support surface, wherein the first support surface of the disc wheel acts together with the at least one effective area of the securing device that is oriented in the axial direction, the second support surface acts together with the additional effective area of the securing segments that is oriented in the radial direction, and the further support surface acts together with the further effective area of the securing segments ;that is oriented in the axial direction.

9. The rotor device according to claim 8, wherein the disc wheel has a recess, in the area of which the first support surface is arranged.

10. The rotor device according to claim 8, wherein the disc wheel has a groove that is formed by a projection and that is open inwards in the radial direction of the rotor device, wherein the first support surface of the disc wheel is a part of the groove, and wherein the projection in particular also comprises the second support surface.

11. The rotor device according to claim 10, wherein the securing segments surround the projection of the disc wheel.

12. The rotor device according to claim 7, wherein the further support surface is arranged at the rotor blades in the area of a cooling air outlet that forms a microturbine.

13. The rotor device according to claim 7, wherein a securing segment has lateral surfaces that are embodied so as to be parallel to each other or so as to substantially extend in the radial direction of the rotor device as viewed in the circumferential direction of the rotor device.

14. The rotor device according to claim 7, wherein at least one retaining appliance is provided for retaining one or multiple securing segments in its or their position.

15. The rotor device according to claim 7, wherein the lateral surfaces of at least two adjacent securing segments are embodied in a design in which they axially overlap each other in the gap area.
